(19) United States
(12) Patent Application Publication
(10) Pub. No.: US 2015/0187508 A1
(43) Pub. Date: Jul. 2, 2015

(54) Electrolytic Capacitor

(71) Applicant: Minwax Electronic Enterprise Ltd., Taipei City (TW)

(72) Inventor: Wei-Yu Cho, Taipei City (TW)

(73) Assignee: Minwax Electronic Enterprise Ltd., Taipei City (TW)

(21) Appl. No.: 14/141,393

(22) Filed: Dec. 26, 2013

(51) Int. Cl. H01G 9/08; H01G 9/048; H01G 9/008

(52) U.S. Cl. CPC H01G 9/08; H01G 9/008; H01G 9/048

(57) ABSTRACT

An electrolytic capacitor, being provided to simplify the manufacturing process and save the manufacturing time and cost, comprises: an element, being an electrolytic capacitor package; a chamber, being a coating film covering the element; a first chamber lead pin, being electrically connected to the element; and a second chamber lead pin, being electrically connected to the element. With the members, the entire structure of electrolytic capacitor is easily formed, of which the weight is lower and the thickness is smaller. Accordingly, the electrolytic capacitor is provided to improve the existing electrolytic capacitor packaging process.

### TECHNICAL FIELD OF THE INVENTION

This invention relates to an electrolytic capacitor and particularly to an electrolytic capacitor of which the manufacturing process may be simplified and the manufacturing time and cost may be saved.

### DESCRIPTION OF THE PRIOR ART

A so-called capacitor is a container that may just save up electric charge. The container only keeps a special substance, electric charge, and the saved positive and negative electric charge is distributed with same quantity on two pieces of electrodes that conduct with each other. The two pieces of electrodes, typically a metal plate, is separated with a dielectric material, the fundamental model of a capacitor being thereby formed. Although the capacitor is somewhat similar to a battery, what is different is the battery that cannot instantly save up electricity and discharge electricity. In practical use, it works mainly for blocking direct current, coupling alternating current, filtering, tuning, phase shifting, energy saving, by-pass, circuit and speaker system networks coupling and the like, and is even applied for saving or discharging the power of a flash light of a camera. Thus, it is inevitable that they are common in different uses; for example, a by-pass capacitor may be also called smooth filtering capacitor, which is based on a viewpoint for explanation. Capacitors are closely related to electrical appliances in our lives.

A commonly familiar electrolytic capacitor is a probably aluminum-made electrolytic capacitor. However, currently, to make an aluminum-made electrolytic capacitor, an aluminum shell is encapsulated with an element and a rubber cover through which a lead pin passes is used to seal the electrolytic capacitor, and then the head of aluminum shell is pressed by rollers of a machine to clamp the rubber cover, which is a means of packaging the existing electrolytic capacitor in production process.

However, according to the trend of miniaturization of electronic products, today's aluminum electrolytic capacitors are getting smaller and smaller; relatively, the rubber cover and aluminum shell are small, thereby making the element very difficult to be set into the aluminum shell. Further, whenever developing a aluminum electrolytic capacitor of new specification, R&D engineers need to re-design for the size of aluminum shell corresponding to the rubber cover, which thereby increases excessive cost and brings defects that are magnified with the trend of miniaturization of electronic products that are developed in the future. At one time, when the electrolytic capacitor is manufactured, because of the size of electrolytic capacitor and the structure design, the yield factor of electrolytic capacitor is impacted and thus the quality of electrolytic capacitor significantly decreases, which thereby lengthens the production man-hour and increases the cost of production.

Owing to the disadvantage of conventional electrolytic capacitor, and the fact that the structure is not ideal, this inventor solves this problem to provide an electrolytic capacitor for actively increasing the economic benefit of manufacturing and the ability of product competition and promoting the development of this industry.

### SUMMARY OF THE INVENTION

This invention is mainly to provide an electrolytic capacitor of which the entire structure is easily formed, the weight is lower, and the thickness is smaller.

The object of this invention is further to provide an electrolytic capacitor, of which the manufacturing process may be simplified and the manufacturing time and cost may be saved.

In order to achieve the object mentioned above, the electrolytic capacitor according to this invention comprises: an element, being an electrolytic capacitor package; a chamber, being a coating film covering the element; a first chamber lead pin, being electrically connected to the element; and a second chamber lead pin, being electrically connected to the element.

Preferably, the element further comprises at least a pair of isolation layers, a first polarity film, and at least a pair of second polarity films. The pair of isolation layers are neutral electrolyte layers that are uncharged, and are vertically arranged and rolled in a direction. The first polarity film, being sandwiched between the pair of isolation layers, is vertically arranged and is rolled with the isolations in a direction. The pair of second polarity films are vertically arranged and opposite to each other and, after the pair of isolation layers and the first polarity film are rolled each circle, are horizontally shifted and then inserted in laterally.

Preferably, the element further comprises an isolation layer, a first polarity film, and a second polarity film. The isolation layer is a neutral electrolyte layer that is uncharged, and is vertically arranged and rolled in a direction. The first polarity film is vertically arranged and, after the isolation layer is rolled each circle, is horizontally shifted in a direction and then inserted in laterally. The second polarity film is vertically arranged and, after the isolation layer is rolled each circle, is horizontally shifted in another direction and then inserted in laterally.

Preferably, the first polarity film is formed with a first electrode lead pin electrically connected to the first chamber lead pin.

Preferably, the second polarity film is formed with a second electrode lead pin electrically connected to the second chamber lead pin.

Preferably, the chamber is soft or rigid.

Preferably, the chamber is made of aluminum, chlorinated polypropylene (CPP), or nylon.

Preferably, the chamber is made of the composition of aluminum, chlorinated polypropylene (CPP), and nylon.

Preferably, the element is flat square or flat circular.

Preferably, the chamber is flat square or flat circular.

In this invention, to implement the packaging process of electrolytic capacitor, the element is arranged in the chamber and then the electrode lead pins of the element are electrically connected to the chamber lead pins that are arranged on the chamber. Then, an aluminum-plastic film (not shown) is used for covering and is sealed around by means of thermal melting, the electrolytic capacitor being thereby packaged.

### BRIEF DESCRIPTION OF THE DRAWINGS

FIG. 1 is a schematic view illustrating a first electrolytic capacitor according to this invention.

FIG. 2 is a sectional view of the first electrolytic capacitor according to this invention.

FIG. 3 is a schematic view illustrating a second electrolytic capacitor according to this invention.

FIG. 4 is a sectional view of the second electrolytic capacitor according to this invention.

FIG. 5 is a view of a first embodiment of this invention.

FIG. 6 is a view of a second embodiment of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

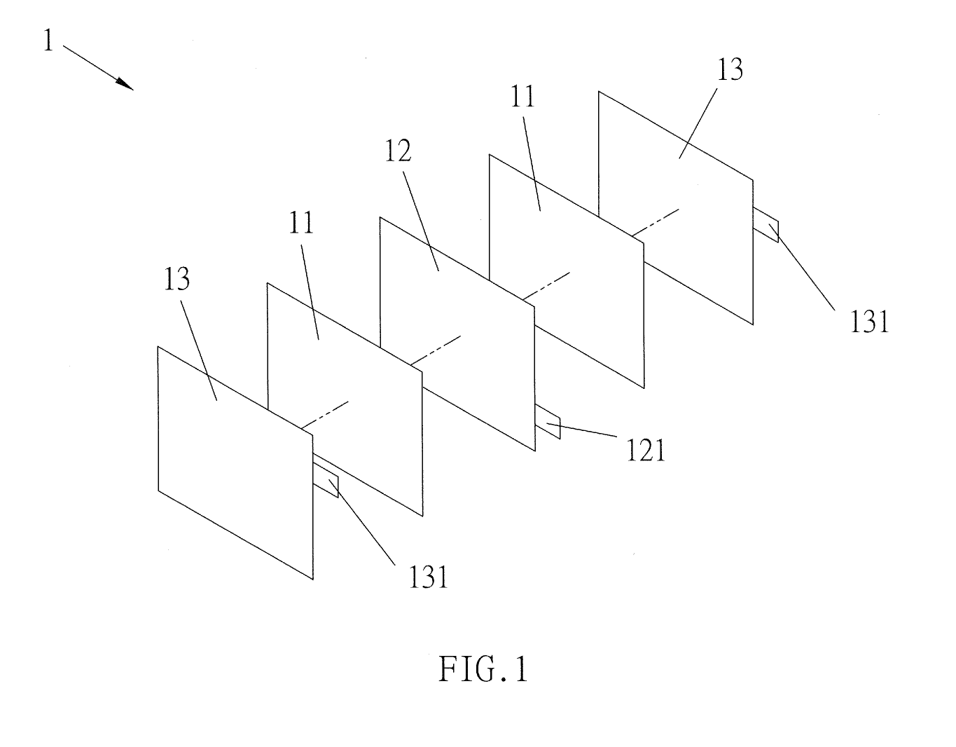

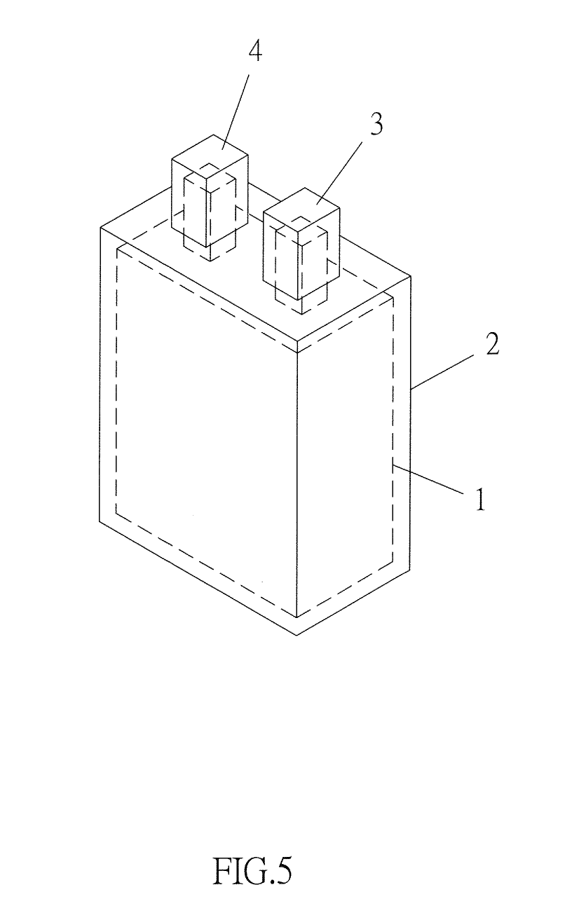

Firstly, refer to FIGS. 1 and 5 shown as a schematic view illustrating a first electrolytic capacitor according to this invention. The electrolytic capacitor according to this invention comprises: an element 1, being an electrolytic capacitor package; a chamber 2, being a coating film covering the element 1; a first chamber lead pin 3, being electrically connected to the element 1; and a second chamber lead pin 4, being electrically connected to the element 1.

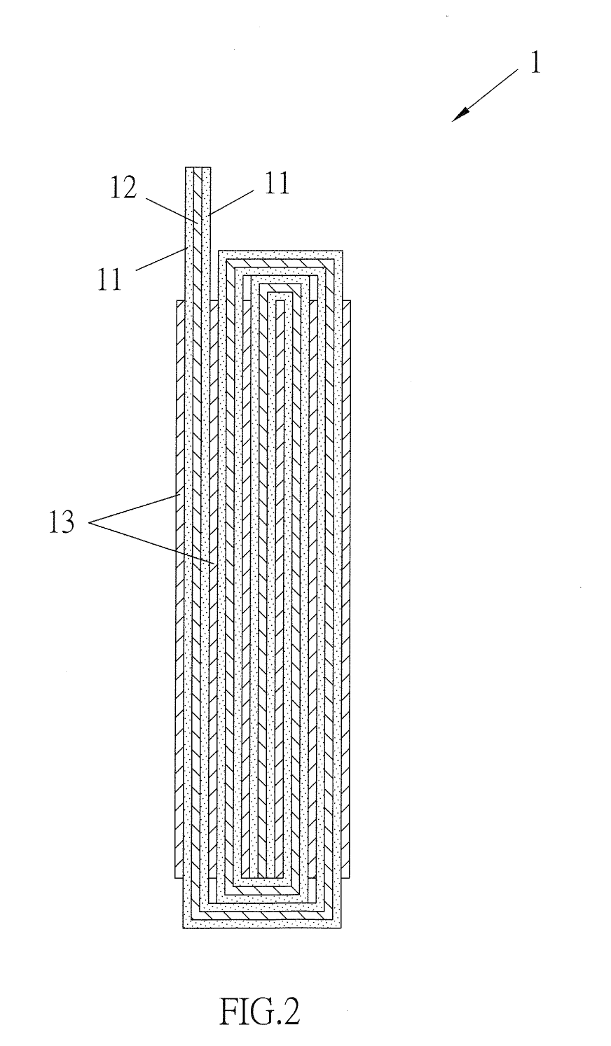

With reference to FIG. 2, the element 1 further comprises at least a pair of isolation layers 11, a first polarity film 12, and at least a pair of second polarity films 13. The pair of isolation layers 11 are neutral electrolyte layers that are uncharged, and are vertically arranged and rolled in a direction. The first polarity film 12, being sandwiched between the pair of isolation layers, is vertically arranged and is rolled with the isolations in a direction. The pair of second polarity films 13 are vertically arranged and opposite to each other and, after the pair of isolation layers 11 and the first polarity film 12 are rolled each circle, are horizontally shifted and then inserted in laterally, as shown in FIG. 2.

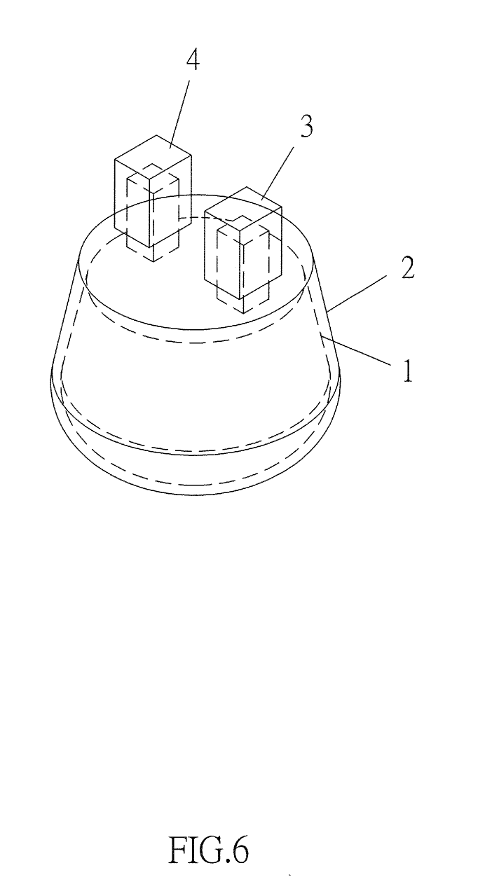

The first polarity film 12 is formed with a first electrode lead pin 121 electrically connected to the first chamber lead pin 3. The second polarity film 13 is formed with a second electrode lead pin 131 electrically connected to the second chamber lead pin 4. The chamber 2 is soft or rigid. Further, the chamber 2 is made of aluminum, chlorinated polypropylene (CPP), or nylon; alternatively, the chamber 2 is made of the composition of aluminum, chlorinated polypropylene (CPP), and nylon. With reference to FIGS. 5 and 6, the element 1 is flat square or flat circular and the chamber 2 is flat square or flat circular.

Refer to FIG. 2 as a sectional view of the first electrolytic capacitor according to this invention. As shown in the figure, the element 1 is formed by rolling the isolation layers 11, the first polarity film 12 and the second polarity film 13 that are stacked to each other.

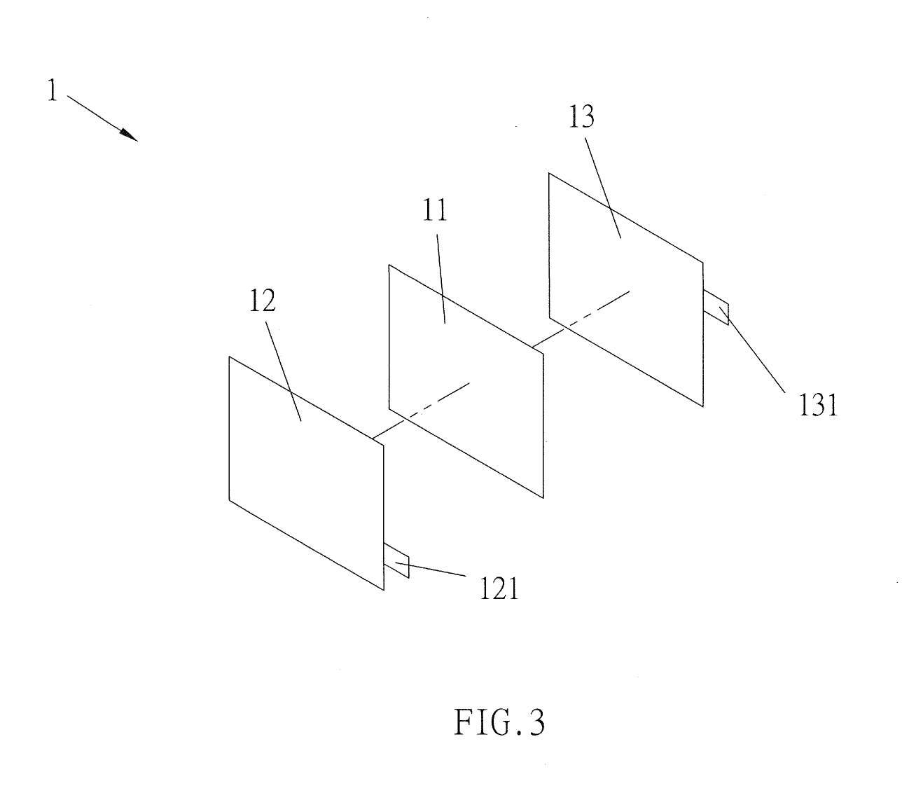

Refer to FIGS. 3 and 5 shown as a schematic view illustrating a second electrolytic capacitor according to this invention. The electrolytic capacitor according to this invention comprises: an element 1, being an electrolytic capacitor package; a chamber 2, being a coating film covering the element 1; a first chamber lead pin 3, being electrically connected to the element 1; and a second chamber lead pin 4, being electrically connected to the element 1.

The element 1 further comprises an isolation layer 11, a first polarity film 12, and a second polarity film 13. The isolation layer 11 is a neutral electrolyte layer that is uncharged, and is vertically arranged and rolled in a direction. The first polarity film 12 is vertically arranged and, after the isolation layer 11 is rolled each circle, is horizontally shifted in a direction and then inserted in laterally. The second polarity film 13 is vertically arranged and, after the isolation layer 11 is rolled each circle, is horizontally shifted in another direction and then inserted in laterally.

The first polarity film 12 is formed with a first electrode lead pin 121 electrically connected to the first chamber lead pin 3, while the second polarity film 13 is formed with a second electrode lead pin 131 electrically connected to the second chamber lead pin 4. The chamber 2 is soft or rigid. Further, the chamber 2 is made of aluminum, chlorinated polypropylene (CPP), or nylon; alternatively, the chamber 2 is made of the composition of aluminum, chlorinated polypropylene (CPP), and nylon. With reference to FIGS. 5 and 6, the element 1 is flat square or flat circular and the chamber 2 is flat square or flat circular.

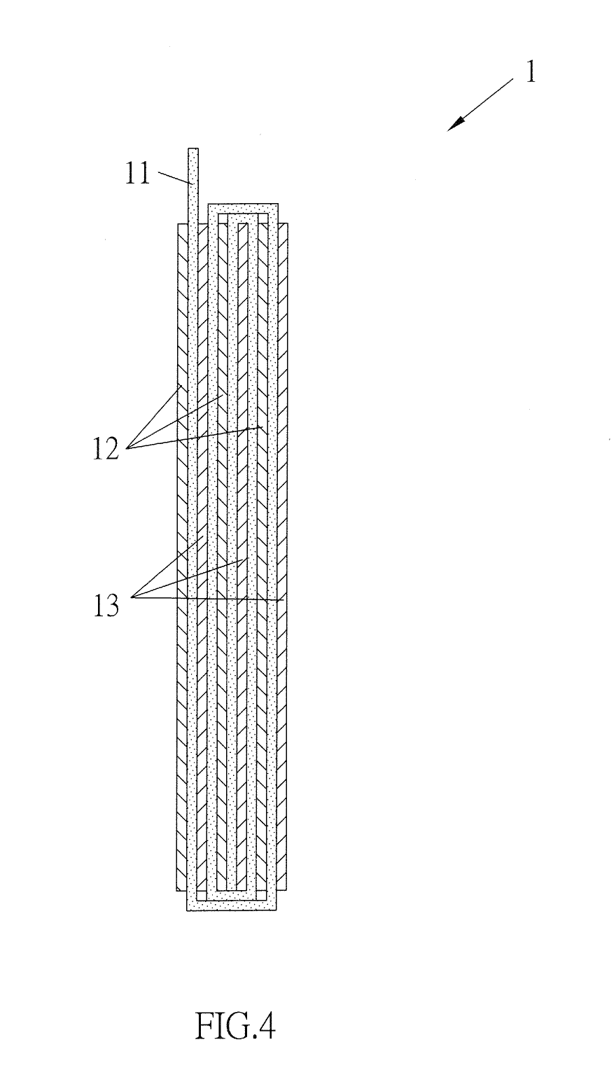

Refer to FIG. 4 as a sectional view of the first electrolytic capacitor according to this invention. As shown in the figure, the element 1 is formed by rolling the isolation layers 11, the first polarity film 12, and the second polarity film 13 that are stacked to each other.

In this invention, to implement the packaging process of electrolytic capacitor, the element 1 is thereby arranged in the chamber 2 and then the electrode lead pins 121 and 131 of the element 1 are electrically connected to the chamber lead pins that are arranged on the chamber 2. Then, an aluminum-plastic film (not shown) is used for covering and is sealed around by means of thermal melting, the electrolytic capacitor being thereby packaged.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

I claim:

1. An electrolytic capacitor, comprising:
an element, being an electrolytic capacitor package;
a chamber, being a coating film covering the element;
a first chamber lead pin, being electrically connected to the element; and
a second chamber lead pin, being electrically connected to the element.

2. The electrolytic capacitor according to claim 1, wherein the element further comprises at least a pair of isolation layers, being neutral electrolyte layers that are uncharged, and are vertically arranged and rolled in a direction; a first polarity film, being sandwiched between the pair of isolation layers, is vertically arranged and is rolled with the isolations in a direction; and at least a pair of second polarity film, being vertically arranged and opposite to each other and, and after the pair of isolation layers and the first polarity film are rolled each circle, being horizontally shifted and then inserted in laterally.

3. The electrolytic capacitor according to claim 1, wherein the element further comprises an isolation layer, being neutral electrolyte layer that is uncharged, and being vertically arranged and rolled in a direction; a first polarity film, being vertically arranged and, after the isolation layer is rolled each circle, being horizontally shifted in another direction and then inserted in laterally; and at least a second polarity film, being vertically arranged and, after the isolation layer is rolled each circle, being horizontally shifted in another direction and then inserted in laterally.

4. The electrolytic capacitor according to claim 2, wherein the first polarity film is formed with a first electrode lead pin electrically connected to the first chamber lead pin.

5. The electrolytic capacitor according to claim 3, wherein the first polarity film is formed with a first electrode lead pin electrically connected to the first chamber lead pin.

6. The electrolytic capacitor according to claim 2, wherein the second polarity film is formed with a second electrode lead pin electrically connected to the second chamber lead pin.

7. The electrolytic capacitor according to claim 3, wherein the second polarity film is formed with a second electrode lead pin electrically connected to the second chamber lead pin.

8. The electrolytic capacitor according to claim 1, wherein the chamber is one of a soft chamber and a rigid chamber.

9. The electrolytic capacitor according to claim 1, wherein the chamber is made of one of aluminum, chlorinated polypropylene (CPP), and nylon.

10. The electrolytic capacitor according to claim 7, wherein the chamber is made of the composition of aluminum chlorinated polypropylene (CPP), and nylon.

11. The electrolytic capacitor according to claim 1, wherein the element is one of a flat square element and a flat circular element.

12. The electrolytic capacitor according to claim 1, wherein the chamber is one of a flat square chamber and a flat circular chamber.

13. The electrolytic capacitor according to claim 9, wherein the chamber is one of a flat square chamber and a flat circular chamber.
